(19) United States
(12) Patent Application Publication
(10) Pub. No.: US 2010/0032898 A1
(43) Pub. Date: Feb. 11, 2010

(54) Color By Symbol Picture Puzzle Kit

(76) Inventor: Anita Jane Gearty, Tinton Falls, NJ (US)

Correspondence Address: Ashok Tankha, 36 Greenleigh Drive, Sewell, NJ, 08080, US

(21) Appl. No.: 12/188,208

(22) Filed: Aug. 8, 2008

(51) Int. Cl. A63F 9/10; G09B 11/00; G09B 19/00

(52) U.S. Cl. 273/157 R; 434/84; 434/98; 434/96

(57) ABSTRACT

Disclosed herein is a picture puzzle kit for enabling a user to color a picture puzzle using symbols representing different colors. The picture puzzle kit comprises puzzle pieces and a color chart. The puzzle pieces, made of plastic, cardboard, or a wooden material, comprise portions of a picture and symbols corresponding to different colors. The picture may be of different designs. The color chart displays different colors with corresponding symbols for the colors. The picture puzzle kit may further comprise a base for supporting the puzzle pieces. The puzzle pieces may be linked to assemble the picture. The puzzle pieces may be linked by interlocking the puzzle pieces or by placing the puzzle pieces adjacent to one another. The picture puzzle kit may further comprise coloring tools to enable the user to color the puzzle pieces using symbols representing the different colors displayed on the color chart.

### BACKGROUND

This invention, in general, relates to puzzles. More particularly, this invention relates to coloring a picture puzzle using symbols representing different colors.

A puzzle is a game that requires ingenuity and persistence in assembling or solving. Puzzles are often devised as a form of entertainment. Puzzles may be divided into different categories, for example, jigsaw puzzles, picture puzzles, transport puzzles, word puzzles, sliding puzzles, logic puzzles, folding puzzles, etc. Typically, puzzles only provide a user a means of assembling puzzle pieces together. There is a need for puzzles that allow a user to be creative by associating different colors for different puzzle pieces.

Hence there is a need for a picture puzzle kit that not only entertains but also allows a user to color a picture puzzle using symbols representing different colors.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The picture puzzle kit disclosed herein addresses the above stated needs for enabling a user to color a picture puzzle using symbols representing different colors and to use the picture puzzle as a plaything, a display item, or for entertainment.

The picture puzzle kit disclosed herein comprises puzzle pieces and a color chart. The puzzle pieces comprise portions of a picture. The picture may be of different designs. The puzzle pieces further display symbols corresponding to the different colors. The color chart displays different colors with corresponding symbols for the colors. The color chart comprises representations of the colors in the background surrounding the corresponding symbols. The picture puzzle kit may also comprise coloring tools to enable the user to color the puzzle pieces. The user may use the coloring tools to apply the actual color on the puzzle pieces. The picture puzzle kit may further comprise a base for supporting the puzzle pieces. The puzzle pieces may be linked to assemble the picture. The puzzle pieces may be linked by interlocking the puzzle pieces or by placing the puzzle pieces adjacent to one another. The puzzle pieces may also be shaped as jigsaw puzzle pieces for interlocking of the puzzle pieces.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1A illustrates puzzle pieces comprising portions of an exemplary picture of a flower pot.

FIG. 1B illustrates puzzle pieces comprising symbols representing different colors placed adjacent to one another to assemble the exemplary picture of the flower pot.

FIG. 2 exemplarily illustrates a color chart for the picture of the flower pot, displaying different colors with corresponding symbols for the colors.

FIG. 3A illustrates puzzle pieces comprising portions of an exemplary picture of an ice cream sundae.

FIG. 3B illustrates puzzle pieces comprising symbols representing different colors, placed adjacent to one another to assemble the exemplary picture of the ice cream sundae.

FIG. 4 exemplarily illustrates a color chart for the picture of the ice cream sundae, displaying different colors with corresponding symbols for the colors.

FIG. 5A illustrates jigsaw puzzle pieces comprising portions of an exemplary picture of a flower.

FIG. 5B illustrates jigsaw puzzle pieces comprising symbols representing different colors, interlocked to assemble the exemplary picture of the flower.

### DETAILED DESCRIPTION OF THE INVENTION

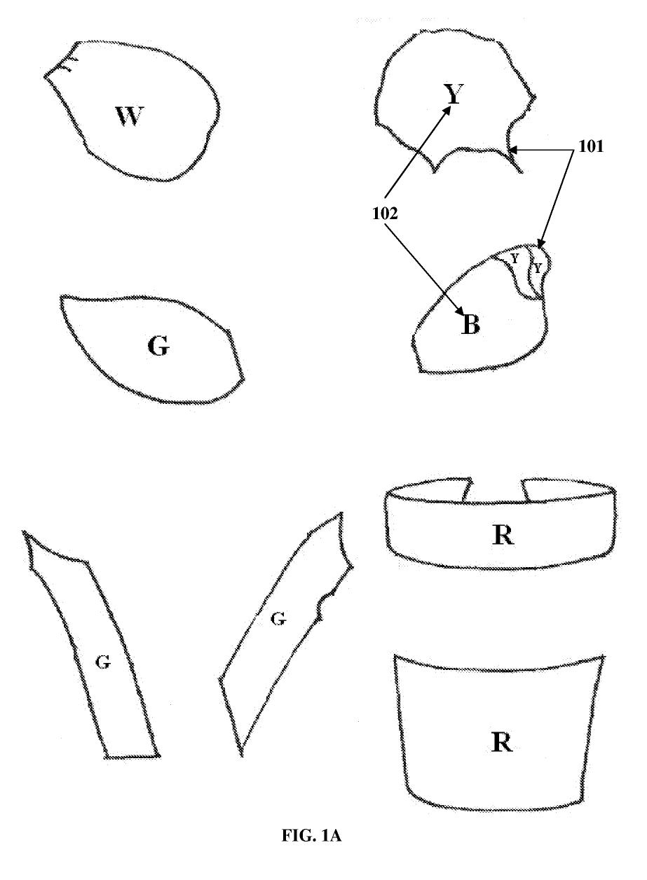

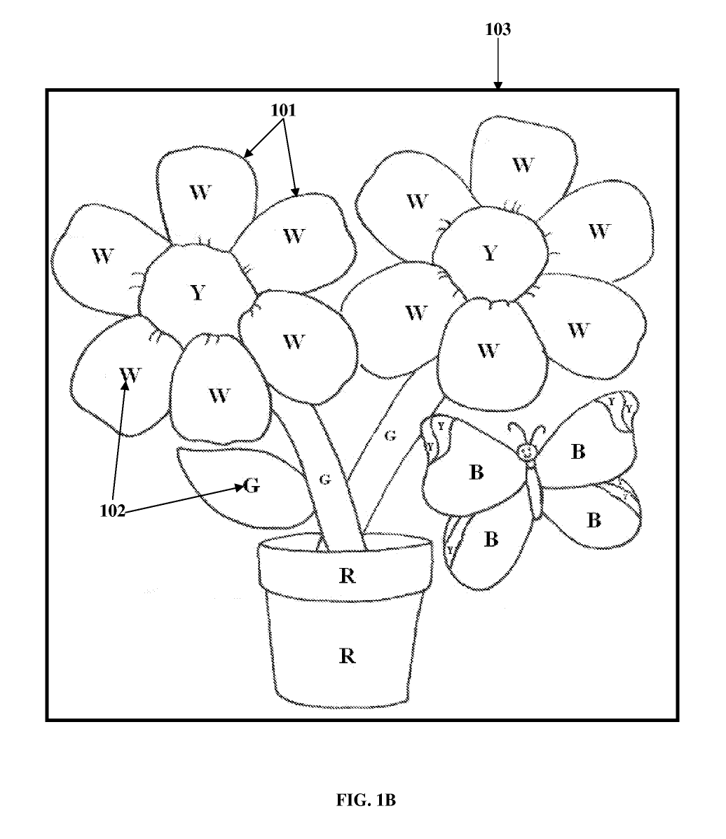

The picture puzzle kit disclosed herein enables a user to color a picture puzzle using symbols 102 representing different colors. The picture puzzle kit disclosed herein comprises puzzle pieces 101 and a color chart 201. The puzzle pieces 101 comprise portions of a picture. FIG. 1A illustrates puzzle pieces 101 comprising portions of an exemplary picture of a flower pot. The puzzle pieces 101 display symbols 102 corresponding to different colors. The symbols 102 displayed on the puzzle pieces 101 may be marked by stamping, engraving, imprinting, impressing, etc. The symbols 102 may be in the form of alphabets corresponding to different colors. For example, in FIG. 1A the puzzle pieces 101 display the symbols W, G, Y, R, and B corresponding to the colors white, green, yellow, red, and blue. The puzzle pieces 101 may be made of plastic, cardboard, or a wooden material. The wooden material may be, for example, a wood composite, a pressed wood, a solid wood, etc. The picture puzzle kit may further comprise a base 103 for supporting the puzzle pieces 101.

The picture is assembled by linking the puzzle pieces 101. The picture may be of different designs. The puzzle pieces 101 may be linked by placing the puzzle pieces 101 adjacent to one another or by interlocking the puzzle pieces 101. FIG. 1B illustrates puzzle pieces 101 comprising symbols 102 representing different colors placed adjacent to one another to assemble the exemplary picture of the flower pot. The puzzle pieces 101 may also be shaped as jigsaw puzzle pieces 501 for linking the puzzle pieces 101 by interlocking.

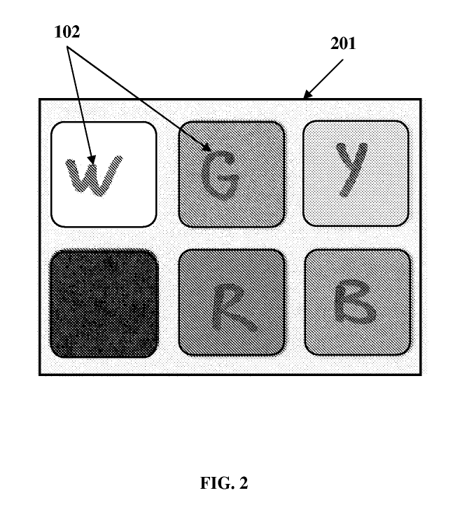

FIG. 2 exemplarily illustrates the color chart 201 for the picture of the flower pot illustrated in FIG. 1B, displaying different colors with corresponding symbols 102 for the colors. The color chart 201 comprises representations of the colors in the background surrounding the corresponding symbols 102. For example, the color chart 201 for the picture puzzle of FIG. 1B comprises symbols 102 W, G, Y, R, and B, for the colors of white, green, yellow, red, and blue respectively. The representations of the colors white, green, yellow, red, and blue are displayed in the background surrounding the symbols W, G, Y, R, and B respectively. The color chart 201 is different for different picture puzzle kits.

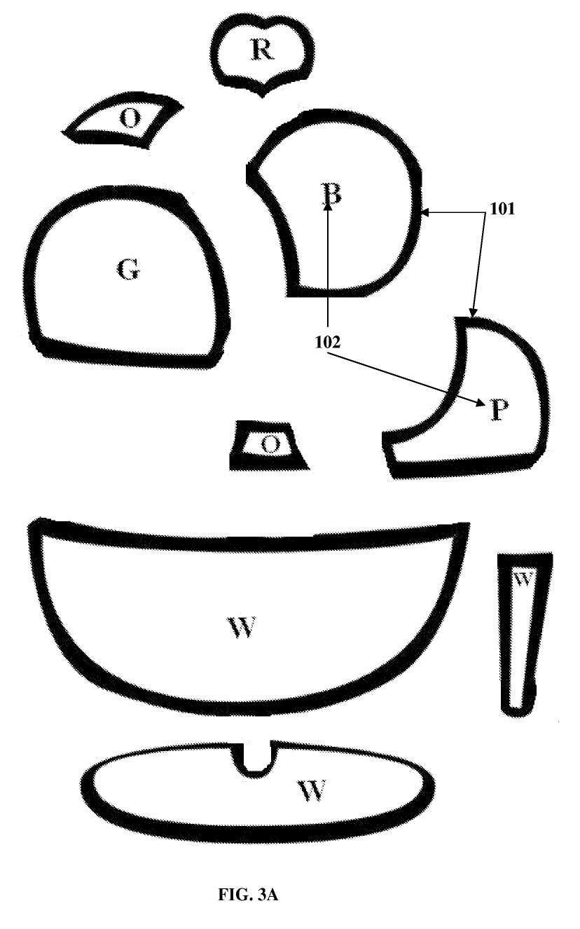

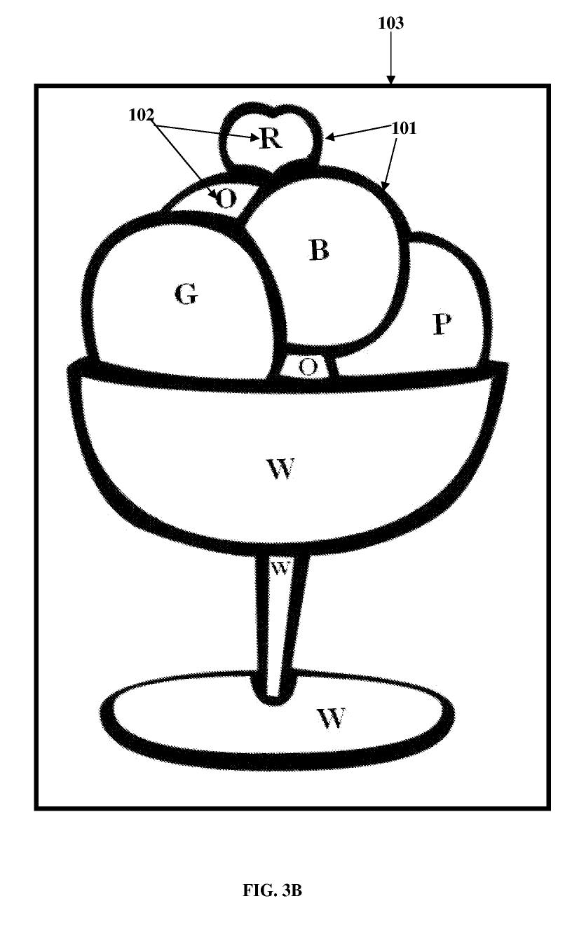

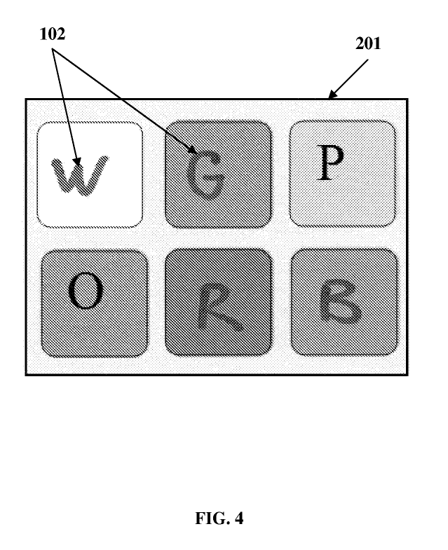

FIG. 3A illustrates puzzle pieces 101 comprising portions of an exemplary picture of an ice cream sundae. The puzzle pieces 101 display the symbols W, G, P, O, R, and B corresponding to the colors white, green, pink, orange, red, and blue respectively. The puzzle pieces 101 comprising the symbols W, G, P, O, R, and B representing different colors are placed adjacent to one another to assemble the exemplary picture of the ice cream sundae as illustrated in FIG. 3B. The color chart 201 for the picture puzzle of FIG. 3B comprises representations of the colors white, green, pink, orange, red, and blue in the background surrounding the symbols W, G, P, O, R, and B respectively as illustrated in FIG. 4. The user, for example, a child will then color the puzzle pieces 101 by coloring the puzzle pieces 101 with the colors displayed on the color chart 201.

The user may color the picture that has been assembled in colors corresponding to the different colors displayed on the color chart 201 using coloring tools provided in the picture puzzle kit. The coloring tools may be crayons, inks, markers, dyes, pigments, or paints for example, acrylic paints, oil paints, water colors, finger paints, etc. The picture puzzle kit may also comprise a brush for painting the picture. The base 103 used to support the puzzle pieces 101 may also be painted using the coloring tools. The user may color the picture before linking the puzzle pieces 101 or after linking the puzzle pieces 101 to assemble the picture. The picture puzzle kit may be used to entertain a user and the puzzle pieces 101 may also be used as a plaything and display item.

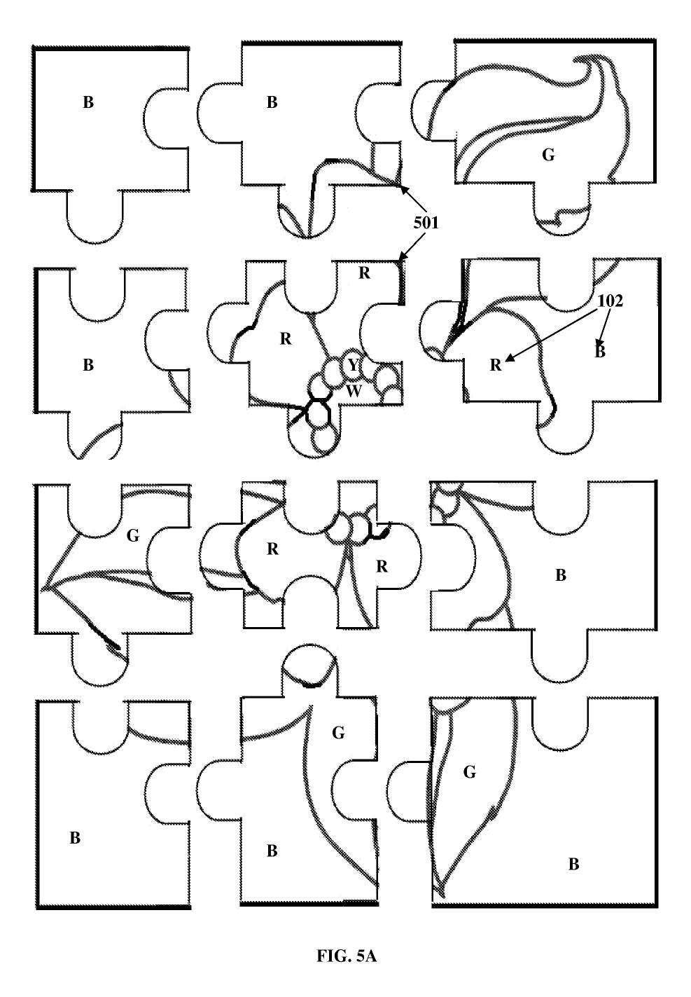

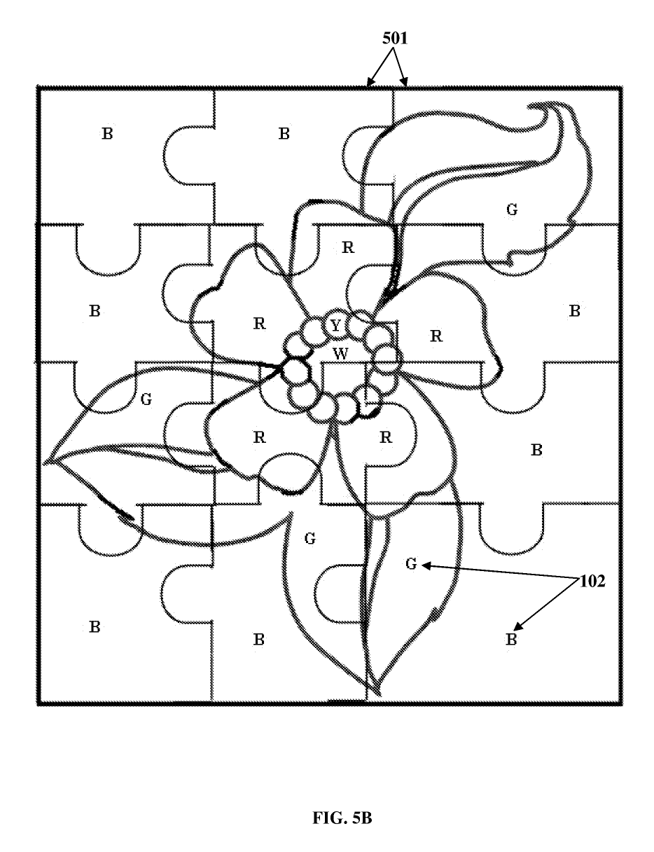

FIG. 5A illustrates jigsaw puzzle pieces 501 comprising portions of an exemplary picture of a flower. The jigsaw puzzle pieces 501 comprise the symbols W, G, Y, R, and B representing the colors white, green, yellow, red, and blue respectively. The picture of the flower is assembled by interlocking the jigsaw puzzle pieces 501 as illustrated in FIG. 5B. The jigsaw puzzle pieces 501 may be of different shapes and sizes. The symbols 102 enable the user to color the jigsaw puzzle pieces 501 using the color chart 201 and the coloring tools. The color chart 201 for the picture puzzle of FIG. 5B is illustrated in FIG. 2. The coloring tools may be, for example, crayons, inks, markers, dyes, pigments, or paints for example acrylic paints, oil paints, water colors, finger paints, etc. The user may use the coloring tools to apply the actual color on the jigsaw puzzle pieces 501. The base 103 may also be used for supporting the jigsaw puzzle pieces 501.

The foregoing examples have been provided merely for the purpose of explanation and are in no way to be construed as limiting of the invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A picture puzzle kit for coloring a picture puzzle using symbols representing different colors, comprising:
puzzle pieces comprising portions of a picture, wherein said picture is assembled by linking said puzzle pieces, wherein said symbols corresponding to said different colors are displayed on the puzzle pieces; and
a color chart for displaying the different colors with corresponding symbols for the colors;
whereby said picture puzzle kit enables a user to color said picture puzzle using symbols representing the different colors displayed on said color chart.

2. The picture puzzle kit of claim 1, wherein said linking is performed by one of interlocking the puzzle pieces and placing the puzzle pieces adjacent to one another.

3. The picture puzzle kit of claim 1, wherein the puzzle pieces are shaped as jigsaw puzzle pieces for interlocking the puzzle pieces.

4. The picture puzzle kit of claim 1, wherein the color chart comprises representations of the different colors in the background surrounding said corresponding symbols.

5. The picture puzzle kit of claim 1, wherein the picture is one of different designs.

6. The picture puzzle kit of claim 1, further comprising coloring tools, wherein said coloring tools enables said user to color the puzzle pieces in colors corresponding to the different colors displayed on the color chart.

7. The picture puzzle kit of claim 6, wherein the coloring tools are one of paints, crayons, inks, markers, dyes, and pigments.

8. The picture puzzle kit of claim 1, wherein the puzzle pieces are made of one of plastic, cardboard, and a wooden material.

9. The picture puzzle kit of claim 8, wherein said wooden material is one of a wood composite, a pressed wood, and a solid wood.

10. The picture puzzle kit of claim 1, further comprising a base for supporting the puzzle pieces.

11. The picture puzzle kit of claim 1, wherein the symbols displayed on the puzzle pieces are marked by one of stamping, engraving, imprinting, and impressing.
